(19) United States
(12) Patent Application Publication
(10) Pub. No.: US 2020/0179866 A1
(43) Pub. Date: Jun. 11, 2020

(54) METHOD AND SYSTEM FOR REMOVING CONTAMINANTS IN GAS USING A LIQUID SCAVENGER

(71) Applicant: SCHLUMBERGER TECHNOLOGY CORPORATION, Sugar Land, TX (US)

(72) Inventors: Z. Frank Zheng, Cypress, TX (US); Dahai Tang, Sugar Land, TX (US); Sandrine Hoebler, Sugar Land, TX (US); Matthew J. Hull, Cypress, TX (US); Gary W. Sams, Spring, TX (US); Ankur D. Jariwala, Katy, TX (US)

(21) Appl. No.: 16/212,076

(22) Filed: Dec. 6, 2018

(51) Int. Cl. B01D 53/14; B01D 53/18; B01D 53/04

(52) U.S. Cl. CPC B01D 53/1412; B01D 53/1493; B01D 2257/50; B01D 53/0407; B01D 53/185

(57) ABSTRACT

Embodiments described herein provide methods of removing contaminants from a gas, the methods including providing a feed gas to a vertical contactor; flowing the feed gas in a gas flow direction through the vertical contactor; mixing a fresh absorbent makeup with a recycled absorbent to form an absorbent mixture; providing a fresh absorbent feed to the feed gas; flowing the absorbent mixture through the vertical contactor in a liquid flow direction counter to the gas flow direction; recovering a clean gas stream from the vertical contactor; and recovering the recycled absorbent from the vertical contactor.

### FIELD

This application generally relates to processing of gas from hydrocarbon reservoirs. Specifically, this application describes methods and apparatus for removing contaminants such as hydrogen sulfide (H₂S) from wellhead gases.

### BACKGROUND

Hydrogen sulfide is a corrosive gas commonly present in hydrocarbon gases extracted from reservoirs. To process the hydrocarbon gases into, for example, usable natural gas, the H₂S is usually removed to reduce chemical attack on facilities. Two general methods currently exist for removing H₂S from wellhead gases. In the first general method, the wellhead gas containing H₂S is bubbled through a liquid that removes the H₂S from the gas. The most popular liquid for scavenging H₂S is a hexahydrotriazine (also known as a triazinane), which has the general formula

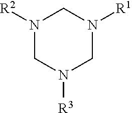

where R¹, R², and R³ are usually hydrogen or small alkyl, alkoxy, or hydroxyalkyl substituents, and may be the same or different. The version where R¹, R², and R³ are all methyl, also known as “MMA triazine” from its monomethylamine precursor, is commonly used. The contacting is typically done in a vessel with a substantially vertical axis or orientation, such as a tower or drum.

In one configuration, the liquid is introduced at or near the top of the vessel while the gas is introduced at or near the bottom of the vessel. The gas bubbles upward through the liquid, which removes H₂S from the gas through contact, and the de-acidified gas is recovered at or near the top of the vessel. In this configuration, the liquid and gas flow in countercurrent paths. Treated gas may entrain some liquid, which can be separated by simple settling or more complicated means.

In another configuration, gas is injected near the bottom of the vessel, but some scavenger liquid is misted into the gas prior to injection into the vessel. In this configuration, gas and liquid flow in concurrent paths, and both are removed near the top of the vessel, either through separate lines or together. Treated gas can be separated from scavenger liquid in subsequent operations.

Another method of contacting a wellhead gas containing H₂S utilizes a mist of the liquid scavenger to contact the gas in a flowing stream. The scavenger liquid is typically misted into the flowing gas stream and the mixture is flowed through a pipe, or other flow vessel, to provide contact residence time. The liquid and gas are then separated. Such processes are also commonly used to remove other contaminant gases such as CO₂ (using amine absorbents), SO₂ (using caustic absorbents), and Hg (using sulfide or thiol absorbents).

Both general methods require relatively large facilities and amounts of liquid scavenger. The bubble contactor uses liquid as the continuous phase. To maintain gas in the dispersed phase, gas superficial velocity must be low, leading to large contactor size. The large contactor is filled with liquid scavenger, some of which becomes overly exposed to acid and solidifies, generating solid waste that must be removed. Misters suffer from low absorption efficiency due to high flow rates and low mist loading needed to maintain droplet dispersion in the gas phase. There is a need in the art for improved apparatus and methods for liquid scavenging of contaminants from wellhead gases.

### SUMMARY

Embodiments described herein provide a method of removing contaminants from a gas, comprising providing a feed gas to a vertical contactor; flowing the feed gas in a gas flow direction through the vertical contactor; mixing a fresh absorbent makeup with a recycled absorbent to form an absorbent mixture; providing a fresh absorbent feed to the feed gas; flowing the absorbent mixture through the vertical contactor in a liquid flow direction counter to the gas flow direction; recovering a clean gas stream from the vertical contactor; and recovering the recycled absorbent from the vertical contactor.

Other embodiments described herein provide a method of removing contaminants from a gas, comprising providing a feed gas to a vertical contactor; flowing the feed gas in a gas flow direction through the vertical contactor; mixing a fresh absorbent makeup with a recycled absorbent to form an absorbent mixture; flowing the absorbent mixture through the vertical contactor in a liquid flow direction counter to the gas flow direction; providing a fresh absorbent feed to the feed gas; recovering a clean gas stream from the vertical contactor; recovering the recycled absorbent from the vertical contactor; detecting an amount of contaminants in the feed gas; determining a theoretical minimum amount of absorbent needed to absorb the contaminants; detecting a chemical condition of the recycled absorbent; setting a flow rate of the fresh absorbent makeup to the recycled absorbent according to the theoretical minimum or the detected chemical condition; and setting a flow rate of the fresh absorbent to the feed gas according to the theoretical minimum or the detected chemical condition.

Other embodiments described herein provide a method of removing sulfur compounds from a gas, comprising providing a feed gas at a feed gas flow rate to a vertical contactor; detecting an amount of sulfur compounds in the feed gas; flowing the feed gas in a gas flow direction through the vertical contactor; determining a theoretical minimum amount of absorbent needed to absorb the sulfur from the sulfur compounds based on the detected amount of sulfur compounds and the feed gas flow rate; mixing a fresh absorbent makeup with a recycled absorbent at a fresh absorbent makeup flow rate at or below the theoretical minimum amount to form an absorbent mixture; flowing the absorbent mixture through the vertical contactor in a liquid flow direction counter to the gas flow direction; recovering a clean gas stream from the vertical contactor; detecting a chemical condition of the recycled absorbent; detecting an amount of sulfur compounds in the clean gas; providing a fresh absorbent feed to the vertical contactor along with the feed gas at a fresh absorbent feed flow rate based on the detected chemical condition and the detected amount of sulfur compounds in the clean gas; and recovering the recycled absorbent from the vertical contactor.

Other embodiments described herein provide methods that include removing contaminants from a gas in a vertical contactor by counter-flow contact between the gas and an absorbent; recycling a portion of the absorbent to the vertical contactor; adding fresh absorbent to the recycled absorbent at a rate equal to the stoichiometric amount of absorbent needed to remove the contaminants; and adding fresh absorbent to the gas prior to entry into the vertical contactor at a rate determined by sensing the chemical condition of the recycled absorbent.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a process flow diagram of a contaminant absorbing apparatus according to one embodiment.

FIG. 2 is a process flow diagram of a contaminant absorbing apparatus according to another embodiment.

FIG. 3 is a flow diagram summarizing a method 300 according to one embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Apparatus and methods are described herein for removing contaminants from a gas through absorption processing. A feed gas is provided to a vertical contactor, where the gas is contacted with an absorbent liquid in counter-flow contact. The gas and absorbent liquid flow in opposite directions in the vertical contactor, coming into intimate contact such that contaminants from the gas enter the absorbent and are removed from the gas. At least a portion of the absorbent is recycled, and fresh absorbent makeup is added to the recycled absorbent. Fresh absorbent is also added to the feed gas prior to entry into the vertical contactor. The flow rate of the fresh absorbent makeup may be set based on a characteristic of the contaminant removal process, such as stoichiometry or solubility. The chemical condition of the recycled absorbent is detected, and the flow rate of fresh absorbent to the feed gas may be set based on the chemical condition. A portion of the recycled absorbent is removed as spent absorbent.

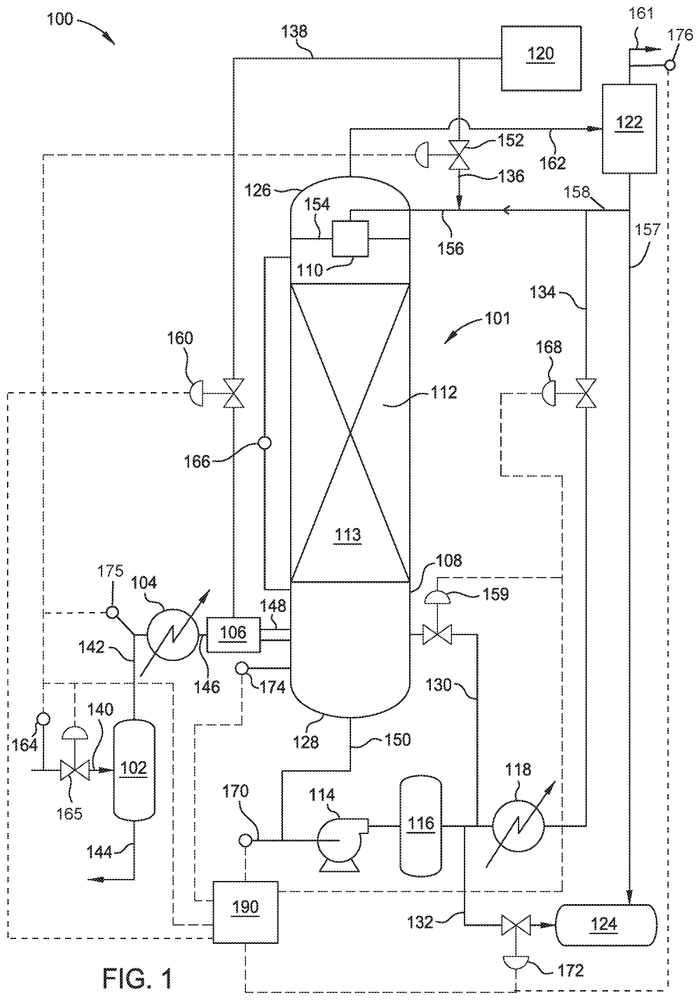

FIG. 1 is a process flow diagram of a contaminant absorbing apparatus 100 according to one embodiment. This contaminant absorbing apparatus 100 can be used to remove sulfur, at least in the form of H₂S, from a wellhead gas produced from a hydrocarbon reservoir. The contaminant absorbing apparatus 100 comprises a vertical contactor 101 with a top 126 and a bottom 128. A contacting structure 112 is disposed in a contacting section 113, between the top 126 and the bottom 128 of the vertical contactor 101. A feed inlet 148 is coupled to the vertical contactor 101 between the contacting structure 112 and the bottom 128. A liquid distributor 110 is disposed between the contacting structure 112 and the top 126. A distributor support 154 is coupled to the liquid distributor 110 and to the interior wall of the vertical contactor 101 to support the liquid distributor 110 above the contacting structure 112. The vertical contactor 101 generally provides counter-flow contact between a mostly gaseous feed provided through the feed inlet 148, which flows upward through the vertical contactor 101, through the contacting structure 112, and liquid absorbent provided through the liquid distributor 110, which flows downward. The contacting structure 112 provides a large surface area for contact between the gas and the absorbent.

A gas stream, which may be a wellhead gas stream, or another stream containing H₂S, or other sulfur compounds or contaminants that need to be removed from the gas stream, is optionally provided to a liquids removal stage 102 through a gas feed line 140. Flow rate of the gas stream may be detected using a flow sensor 164 coupled to the gas feed line 140. Flow rate of the gas stream may be controlled using a gas feed control valve 165 disposed in the gas feed line 140. The liquids removal stage 102 removes liquids from the gas stream through settling, density separation, or other separation means. A liquid line 144 is coupled to the liquids removal stage 102 to remove separated liquids, and a dry gas line 142 also exits the liquids removal stage 102 carrying a dry gas stream. The liquid line 144 can be routed to remediation and/or disposal or to another destination for any desired use of the separated liquids. If desired, a liquid level can be detected in the liquids removal stage 102, and flow rate of liquids through the liquid line 144 can be controlled based on the detected liquid level in the liquids removal stage 102.

The dry gas is optionally heated in preheater 104. A preheated gas line 146 is coupled to the preheater 104 and to a feed mixer 106. A fresh absorbent line 138 is also coupled to the feed mixer 106. The feed mixer 106 produces a mixture of dry preheated gas and fresh absorbent for charging to the vertical contactor 101. The fresh absorbent line 138 is coupled to a fresh absorbent source 120, such as a tank or drum. The feed mixer 106 may be, or may include, an aerosol generator, such as an atomizer or nebulizer, to form an aerosol or mist of the fresh absorbent in the preheated dry gas. Flow rate of fresh absorbent to the feed mixer 106 is controlled by a fresh absorbent control valve 160. The feed inlet 148 is coupled to the feed mixer 106 to carry the gas/absorbent mixture to the vertical contactor 101.

In general, the absorbent is selected to remove the particular contaminants of the gas stream. For example, an amine absorbent can be used to remove CO₂, a caustic absorbent can be used to remove SO₂, and sulfide or thiol absorbents can be used to remove Hg.

The contacting structure 112 is a structure having a high surface area that is disposed in the contacting section 113 of the vertical contactor 101. The contacting structure may be a loose material, such as a packing material, or a semi-rigid or rigid structure with an articulated surface to provide a very high surface area supporting intimate contact between a material disposed on the contacting structure 112 and a gas flowing through the contacting structure 112. A liquid material is disposed on the contacting structure 112, and flows through the contacting structure 112 through numerous flow pathways provided by the articulated nature of the structure, coating the surfaces and providing a very high liquid surface area for contacting a gas. The gas likewise flows through the flow pathways to contact the liquid. Contacting structures that can be used include structured and unstructured packings, discrete or interlocking trays, which may have surface area features such as shapes, holes, curved surfaces, and the like, baffled inserts, or randomly articulated rigid inserts.

The gas provided to the vertical contactor 101 rises through the contacting structure 112. Liquid absorbent provided to the liquid distributor 110 is dispersed, for example sprayed or atomized, onto the top of the contacting structure 112. The liquid absorbent flows downward through the contacting structure 112 contacting the upward flowing gas. The high surface area provided by the contacting structure provides very high area of contact between the gas and the liquid, which promotes a high rate of diffusion of contaminant such as acidic sulfur compounds, for example H₂S or SO₂, into the liquid. H₂S reacts with nitrogen in the triazine ring to produce thiadiazine (one nitrogen replaced with sulfur), a dithiazine (two nitrogens replaced with sulfur), or a trithiane (all three nitrogens replaced with sulfur). The three sulfur-containing species exist in a distribution as the nitrogen-sulfur reactions proceed. For example, H₂S can replace a nitrogen atom in a triazine molecule, a thiadiazine molecule, or a dithiazine molecule, as governed by the reaction kinetics of the system. Fresh triazine absorbent is high in pH, for example about 11 to 12. It is believed that the above reactions liberate amines that lower the pH of the system. Thus, as triazine absorbent is used, pH of the gas/absorbent system declines.

Low pH absorbent is known to be more effective at removing sulfur in many cases than high pH absorbent. It is believed that rate of protonation of a nitrogen atom in a triazine ring, which is the first step in replacement of the nitrogen atom with sulfur, is dependent on concentration of protons in the mixture, and therefore dependent on pH. Thus, use of recycled absorbent improves the effectiveness and efficiency of sulfur removal. Here, recycled absorbent is provided to the vertical contactor 101 through a recycle absorbent line 134 that carries recycled absorbent to the liquid distributor 110. Fresh absorbent makeup may be provided through a fresh absorbent makeup line 136 coupled to the recycle absorbent line 134 and to the fresh absorbent source 120. A flow rate of fresh absorbent makeup can be controlled using a fresh absorbent makeup control valve 152 disposed in the fresh absorbent makeup line 136. An absorbent distribution line 156 carries the mixed recycle and fresh absorbent to the liquid distributor 110.

As noted above, the reaction of triazine with sulfur containing compounds leads to displacement of nitrogen atoms in the triazine ring with sulfur atoms, leading to thiadiazines, dithiazines, and trithianes. Solubility of these molecules in triazine declines with increasing sulfur content, with trithiane having the lowest solubility. In addition, the sulfur containing ring species can polymerize under certain circumstances, with tendency to polymerize increasing as pH declines. Thus, insolubles can be produced by the reactions. Other reactions may also produce insolubles. These insolubles can deposit on, or otherwise foul, the contacting structure 112 resulting in constricted flow pathways through the contacting structure 112. As flow pathways are constrained, pressure drop through the contacting structure 112 can increase. A pressure drop sensor 166 may be provided to monitor pressure drop across the contacting structure 112.

Liquid absorbent flows downward through the contacting structure 112 and collects at the bottom 128 of the vertical contactor 101. Absorbent is removed through a bottoms line 150, and a bottoms pump 114 boosts pressure of the liquid. Insolubles are filtered in a filter 116, and the bottoms liquid is then routed to one of three destinations. A bottoms recirculation line 130 can be coupled to the effluent of the filter 116 to recirculate filtered liquid to the bottom 128 of the vertical contactor 101. The recirculation line 130 can be used to clean the liquid by circulating bottoms liquid through the filter 116 at a rate higher than the general rate of flow through the tower. A control valve 159 can be disposed in the recirculation line 130 to control rate of recirculation of absorbent to the bottom 128 of the vertical contactor 101. Some recycle absorbent emerging in the effluent of the filter 116 can be removed as spent absorbent in a spent absorbent line 132 coupled to the effluent of the filter 116. The spent absorbent line 132 can be coupled to a spent absorbent disposal 124, such as a tank or process for disposing of spent absorbent.

A chemical condition sensor 170 may be coupled to the bottoms line 150 to detect the chemical condition of the recycle absorbent in the bottoms line 150. The sensor 170 may be a density detector, a viscosity detector, a pH detector, an electrical conductivity or resistivity detector, a turbidity detector, and/or a molecular detector such as a gas chromatograph. Maximum values of density, viscosity, turbidity, and molecular weight may be specified, a range of electrical conductivity and/or resistivity may be specified, and/or minimum values of pH may be specified, to support controlling an amount of fresh absorbent provided to the system, or to support controlling an amount of spent absorbent removed from the system. A controller 190 receives a signal from the sensor 170 that represents the chemical condition of the recycle absorbent in the bottoms line 150. Flow rate of the spent absorbent flowing to the disposal 124 through the spent absorbent line 132 is controlled using a spent absorbent control valve 172 disposed in the spent absorbent line 132. Based on the signal from the detector, the controller 190 can signal the spent absorbent control valve 172 to open or close to adjust the chemical condition of the recycle absorbent.

The controller 190 can also signal the fresh absorbent makeup control valve 152 to open or close to adjust the chemical condition of the recycle absorbent. Adding more fresh absorbent at the top 126 of the vertical contactor 101, other things being equal, will improve the chemical condition of the recycle absorbent withdrawn from the bottom 128 of the vertical contactor 101 through the bottoms line 150. A liquid level can be maintained in the bottom 128 of the vertical contactor 101, if desired, and a level detector 174 can be used to control the liquid level. The controller 190 receives a signal from the level detector 174, and can signal the spent absorbent control valve 172 to open or close to maintain the liquid level. Thus, at least two representative control schemes can be used to maintain chemical condition of the recycle absorbent. The signal from the chemical condition sensor 170 can be used to directly adjust flow rate of spent absorbent using the spent absorbent control valve 172, and the controller 190 can then adjust the flow rate of fresh absorbent added through the absorbent distribution line 156 to maintain total flow rate of absorbent in the vertical contactor 101. Alternately, the controller 190 can use the signal from the chemical condition sensor 170 to adjust the flow rate of fresh absorbent, and the signal from the level detector 174 to adjust the flow rate of spent absorbent.

It should be noted that the flow rate of spent absorbent can also be controlled based on material balance of total absorbent around the vertical contactor 101. For example, spent absorbent flow rate to the spent absorbent disposition can be set to the sum of all fresh absorbent flow rates to the vertical contactor 101 through the fresh absorbent makeup control valve 152 and the fresh absorbent feed control valve 160. The controller 190 can determine the spent absorbent flow rate and set the target flow rate for the spent absorbent control valve 172 accordingly.

Clean gas is removed from the top 126 of the vertical contactor 101 through clean gas line 162 and is routed to a clean gas separator 122, where residual liquid absorbent is settled. Clean dry gas exits the clean gas separator 122 through a clean dry gas line 161 and recovered absorbent is routed to the spent absorbent disposal 124 through a recovered absorbent line 157. If desired, the recovered absorbent can also be routed to the recycle absorbent line 134 through a recovered absorbent recycle line 158.

As noted above, use of recycle absorbent takes advantage of the improved reaction rate of compounds like H₂S with absorbents such as triazines. To maintain a process operating temperature, the recycle absorbent may be heated using a recycle absorbent heater 118 disposed in the recycle absorbent line 134. Flow rate of the recycle absorbent can be controlled using a recycle absorbent control valve 168 disposed in the recycle absorbent line 134 and coupled to the controller 190.

An optional first gas composition sensor 175 can be coupled to the dry gas line 142 to sense the composition of the dry gas. An optional second gas composition sensor 176 can be coupled to the clean dry gas line 161 to sense the composition of the clean dry gas. An amount of sulfur compounds, or other contaminants, in each stream can be measured by the gas composition sensors 175 and 176. From the flowrate of each stream and the amount of contaminants in each stream, an amount of contaminants removed from the gas can be computed. If the contaminants are known, and the absorbent is known, consumption of reactive sites in the absorbent can be computed.

The sensors 175 and 176 are operatively coupled to the controller 190 so that the controller 190 can receive signals representing the amount of sulfur compounds in each of the gas flowing through the dry gas line 142 and the clean dry gas line 161. From the amount of contaminants removed, a theoretical minimum amount of absorbent needed to remove the amount of contaminants can be computed. The controller can compare the theoretical minimum amount of absorbent needed to the flow rate of fresh absorbent at the fresh absorbent makeup control valve 152 and the fresh absorbent feed control valve 160. A control scheme can be structured that slowly moves the fresh absorbent flow rate at the fresh absorbent makeup control valve 152 toward the theoretical minimum minus the flow rate through control valve 160 so long as chemical condition of the recycle absorbent detected by the chemical condition sensor 170 remains nominal. As noted above, if the chemical condition of the recycle absorbent becomes unacceptable, the flow rate of fresh absorbent can be increased through either fresh absorbent control valve 152 or 160.

The controller 190 can be configured to operate at least two control loops to control the fresh absorbent flow rate at the fresh absorbent control valves 152 and 160. In a first control loop, the controller 190 can be configured to increase the flow rate of fresh absorbent by opening the fresh absorbent makeup control valve 152 when chemical condition of the recycle absorbent, as defined by the signal sent by the chemical condition sensor 170 to the controller 190, is out of tolerance. In the first control loop, the controller 190 can increase a target flow rate of fresh absorbent at the fresh absorbent makeup control valve 152 while the chemical condition of the recycle absorbent is out of tolerance and stop increasing the target flow rate when the chemical condition returns to tolerance.

In a second control loop, the controller 190 can be configured to decrease the flow rate of fresh absorbent toward the limit of the theoretical minimum amount of fresh absorbent needed, as determined by calculation based on the contaminants being removed from the gas, as defined by the signals from the sensors 175 and 176 to the controller 190. While the chemical condition of the recycle absorbent remains nominal and the total flow rate of fresh absorbent at the control valves 152 and 160 remains above the theoretical minimum, the controller 190 can lower the target flow rate of fresh absorbent through either control valve 152 or 160. The first control loop can be tuned to respond faster than the second control loop to ensure the chemical condition of the recycle absorbent is maintained within tolerance. In this way, efficiency of operating of the apparatus 100 can be improved.

In another aspect, the controller 190 can be configured to operate the apparatus 100, using the first and second gas composition sensors 175 and 176 according to a hierarchical control method. As noted above, the controller 190 can determine the theoretical minimum amount of absorbent needed to absorb all the contaminants of the dry gas using the apparatus 100. The flow rate of dry gas in the dry gas line 142, along with the detected amount of contaminants in the dry gas detected by the first gas composition sensor 175, can be used to determine the theoretical minimum amount of absorbent needed to remove the contaminants according to stoichiometry. The controller 190 can be configured to set the target flow rate for the fresh absorbent makeup control valve 152 according to the determined theoretical minimum amount of absorbent.

The controller 190 can also be configured to monitor contaminants detected by the second gas composition sensor 176 and the chemical condition of the recycle absorbent detected by the chemical condition sensor 170. If contaminants detected by the second gas composition sensor 176 or chemical condition detected by the chemical condition sensor 170 is out of tolerance, the controller 190 can be configured to add additional fresh absorbent at the feed mixer 106 by increasing the target flow rate of the fresh absorbent feed control valve 160. If the chemical condition detected by the chemical condition sensor 170 and the contaminants detected by the second gas composition sensor 176 are both within tolerance, the controller 190 can be configured to reduce the target flow rate of the fresh absorbent feed control valve 160 periodically to minimize use of fresh absorbent.

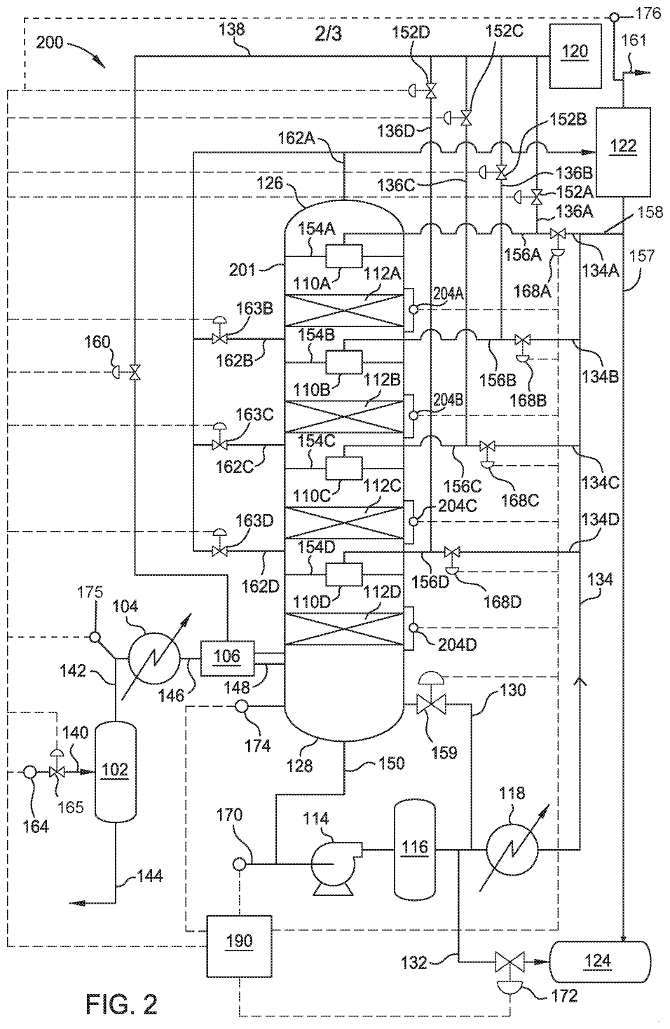

FIG. 2 is a process flow diagram of an absorbing apparatus 200 according to another embodiment. The apparatus 200 is similar in many respects to the apparatus 100, and the same features are numbered using the same reference numerals in both figures. The apparatus 200 differs from the apparatus 100 chiefly in that the apparatus 200 includes a vertical contactor 201 that has multiple contacting structures 112 and liquid distributors 110. Here, four contacting structures 112A, 112B, 112C, and 112D are used in the contacting section 113 of the vertical contactor 201, with four liquid distributors 110A, 1106, 110C, and 110D disposed above each of the respective contacting structures and supported by respective supports 154A, 154B, 154C, and 154D. Each liquid distributor 110A-D is coupled to a respective absorbent distribution line 156A, 156B, 156C, and 156D. The recycle absorbent line 134 separates into four recycle absorbent lines 134A, 134B, 134C, and 134D, each of which couples to a respective fresh absorbent makeup line 136A, 1366, 136C, and 136D, feeding into the respective absorbent distribution lines 156A, 156B, 156C, and 156D.

Flow rates of fresh and recycle absorbent to each absorbent distribution line 156A-D are controlled by control valves, one in each branch of the recycle absorbent line 134A-D and one in each absorbent distribution line 156A-D. Thus, four fresh absorbent makeup control valves 152A, 152B, 152C, and 152D are disposed in the respective fresh absorbent makeup lines 136A, 136B, 136C, and 136D, and four recycle absorbent control valves 168A, 168B, 168C, and 168D are disposed in the respective recycle absorbent lines 134A, 134B, 134C, and 134D. The control valves 152A-D and 168A-D are all coupled to the controller 190 to enable control of absorbent flow rates to the respective liquid distributors 110A-D.

A pressure drop detector 204A, 204B, 204C, 204D is disposed across each respective contacting structure 112A, 112B, 112C, and 112D to detect any loss of flow in each contacting structure due to fouling of the contacting structure. The pressure drop detectors are coupled to the controller 190 to provide the ability to monitor performance of each contacting structure 112A-D.

As with the apparatus 100, clean gas exits the top 126 of the vertical contactor 201 through a clean gas line 162A, which is coupled to the clean gas separator 122. Additional clean gas lines 162B, 162C, and 162D are provided above each of the other respective liquid distributors 1106, 110C, and 110D. Each of the clean gas lines 162B, 162C, and 162D has a respective clean gas control valve 163B, 163C, and 163D.

The apparatus 200 has the ability to respond to any degradation in the performance of a contacting structure 112 in several ways. If one of the upper contacting structures 112A, 1126, or 112C becomes fouled such that the performance of the overall apparatus 200 is compromised, the controller 190 can detect a rise in pressure drop across that contacting structure from the signals received from the pressure drop detectors 204A-D. If, for example, one of the pressure drop detectors 204A-D records a pressure drop significantly higher than the pressure drop readings from the other detectors, the controller 190 may activate a response. In one case, the controller 190 can stop flow of absorbent to the liquid distributor above that contacting structure. Total volume of absorbent can be preserved by distributing some or all absorbent going to any liquid distributors above the fouled contacting structure to the other liquid distributors below the fouled contacting structure. Reducing liquid flow in the contacting structure will reduce pressure drop. If the reduction in pressure drop of the fouled contacting structure is insufficient from merely reducing flowrate through the fouled contacting structure, the controller 190 may stop flow of absorbent to all liquid distributors above that contacting structure. For example, if contacting structure 112C is fouled, and stopping flow of absorbent to liquid distributor 110C does not satisfactorily reduce the pressure drop, flow to the liquid distributors 110A and 1106 can also be stopped to eliminate liquid flow through the contacting structure 112C altogether. In that case, enhanced contacting between liquid and gas will only take place in the contacting structure 112D. Substantial elimination of liquid flow through the contacting structure 112C will reduce pressure drop further. If the pressure drop is still too high, the clean gas control valve 163 immediately below the fouled contacting structure can be activated to route clean gas out of the vertical contactor 201, bypassing the portion of the vertical contactor 201 including and above the fouled contacting structure. For example, if contacting structure 112C is too fouled to support liquid flow and full rate gas flow, the clean gas control valve 163D can be opened to route clean gas directly to the clean gas separator 122 through clean gas line 162D.

The vertical contactor 201 also has the ability to operate with one or more of the contacting structures 112 removed. In the example above, if fouled contacting structure 112C is removed for cleaning, and a replacement contacting structure is not immediately available, the vertical contactor 201 can be operated with contacting structures 112A, 112B, and 112D in place. Flow of absorbent to the liquid distributor 110C is stopped, while flow to the other liquid distributors 110A, 1106, and 110D is maintained.

The vertical contactor 201 also has the ability to adjust contaminant removal efficiency by adjusting absorbent flow rate to the liquid distributors 110A-D. As noted above, consumption of reactive sites, pH, molecular weight, and development of insolubles can affect the overall effectiveness of the process. Thus, the flow rates to the liquid distributors 110A-D can be adjusted to provide more or less contacting time and surface area for gas/liquid contact. If gas cleaning is below target, for example if some residual sulfur compounds or other contaminants are detected in the clean dry gas line 161, flow of absorbent may be increased to higher liquid distributors, such as the liquid distributors 110A and 1106, to provide more contact time between gas and liquid. Total flow of absorbent in the vertical contactor 201 can also be increased by increasing one or more of the recycle absorbent flow rate or the fresh absorbent flow rate using the fresh absorbent makeup control valves 152A-D and the recycle absorbent control valves 168A-D. If such increased contact results in more molecular weight and insolubles, as reflected in readings from the chemical condition sensor 170, filtering may be increased by opening the recirculation control valve 159, or more spent absorbent can be sent to the spent absorbent disposal 124 by opening the spent absorbent control valve 172. As described above, if more spent absorbent is removed, the controller 190 can be configured to increase fresh absorbent makeup using the fresh absorbent makeup control valves 152A-D or at the feed mixer 106. If gas cleaning is above target, use of absorbent can generally be reduced by reversing the actions described above. Contaminant content in the clean dry gas can be monitored using methods well known in the art.

It should be noted that any reasonable number of contacting structures 112 can be used in a vertical contactor such as the vertical contactor 201. For example, although four contacting structures 112 are shown in the vertical contactor 201, two, three, five, six, or any other reasonable number of contacting structures may be used. It should also be noted that more than one vertical contactor 201 can be arranged in series to accommodate more contacting structures, if desired. Thus, a first vertical contactor can have a first plurality of contacting structures and a second vertical contactor can have a second plurality of contacting structures, where liquid from the bottom of the first vertical contactor is routed to the top of the second vertical contactor and gas from the top of the second vertical contactor is routed to the bottom of the first vertical contactor. Two vertical contactors, thus configured, can have all the features and capabilities described above in connection with the single vertical contactor 201.

The contacting sections 113 shown herein generally have dimensions that are the same as other regions of the vertical contactors 101 and 201. In other embodiments, the contacting sections 113 may have dimensions different from other regions of the vertical contactors 101 and 201. For example, the contacting sections 113 may have diameters that are smaller or larger than other regions of the vertical contactors 101 and 201. In cases where multiple contacting structures 112 are used, some contacting sections 113 may be larger, and others smaller than the other regions of the vertical contactor 201.

In the embodiments described herein, the contacting structures 112 are depicted as occupying the entire lateral space from one wall to the opposite wall of the vertical contactors 101 and 201. In other embodiments, the contacting structures 112 may occupy only part of that space, providing open space to one side or another, or on multiple sides, of the contacting structure. Such open spaces may be provided to selectively control contact between the gas and liquid phases in the vertical contactors 101 and 201.

It should also be noted that a contacting structure 112 may include more than one type of structure in a single contacting structure 112. For example, a single contacting structure 112 may include a loose section and a rigid section. For example, a packing material can be disposed between two rigid contactors to make a contacting structure 112. Other composite structures may also be envisioned for use as a contacting structure 112.

As in the apparatus 100 of FIG. 1, gas composition sensors can be used to monitor removal of contaminants from the gas in the apparatus 200. The gas composition sensors 175 and 176 can be included, as in FIG. 1, and operatively coupled to the controller 190. As in the apparatus 100, the controller 190 can be configured to determine a theoretical minimum amount of fresh absorbent needed to accomplish the contaminant removal indicated by the signals from the sensors 175 and 176, and the flow rates of each stream. Fresh absorbent flow through any of the control valves 152A-D or 160 can be diminished such that the total flow through all the control valve 152A-D and 160 approaches the theoretical minimum, so long as the chemical condition of the recycle absorbent, as indicated by the signals received by the controller 190 from the sensor 170, remain within tolerance.

Similar to the controller 190, the controller 238 can have three control loops to control fresh absorbent usage in the apparatus 200. The first and second control loops of the controller 238 can be the same as those described for the controller 190. The third control loop can control total use of fresh absorbent at all three of the control valves 242A, B, and C, as described above. The third control loop can be tuned to respond more slowly than the first and second control loops. In this way, the overall use of fresh absorbent can be minimized and efficiency of the apparatus 200 can be improved.

In another aspect, a hierarchical control method can be implemented for the apparatus 200 similar to that described above for the apparatus 100. The controller 238 can be configured to monitor the amount of contaminants in the dry gas using the first gas composition sensor 175, the amount of contaminants in the clean gas flowing through the clean dry gas line 161, and to determine a theoretical minimum amount of absorbent needed based on the contaminants detected by the first gas composition sensor 175 and the flow rate through the dry gas line 142 as described above. The controller 238 can be configured to apply a maximum limit to the sum of the target flow rates for the fresh absorbent makeup control valves 152A-D such that the total fresh absorbent flowing through the fresh absorbent makeup lines 136A-D does not exceed the theoretical minimum.

The controller 238 can also be configured to monitor the chemical condition of the recycle absorbent detected by the chemical condition sensor 170 as well as contaminants detected in the clean dry gas at second gas composition sensor 176. If the contaminants detected by the second gas composition sensor 176 or the chemical condition detected by the chemical condition sensor 170 is out of tolerance, the controller 238 can be configured to add fresh absorbent to the feed mixer 106 by opening the fresh absorbent feed control valve 160. The controller 238 can also be configured to reduce the fresh absorbent to the feed mixer 106 periodically by partially closing the fresh absorbent feed control valve 160 if the chemical condition detected by the chemical condition sensor 170 and the contaminants detected by the second gas composition sensor 176 are within tolerance. The hierarchical control structure described above can be implemented in addition to the various other controls described above for the apparatus 200.

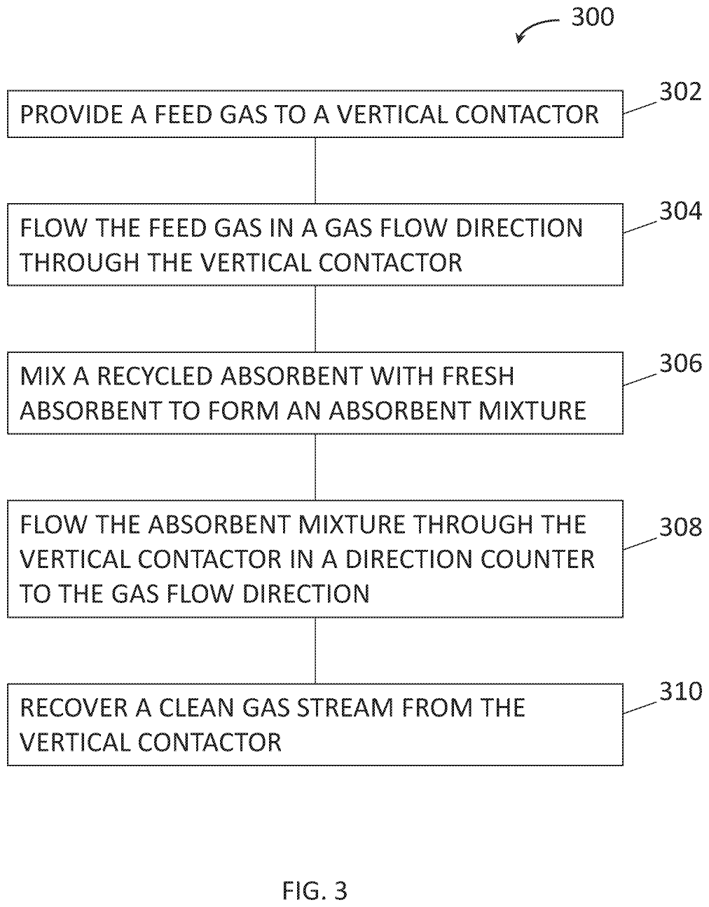

FIG. 3 is a flow diagram summarizing a method 300 according to one embodiment. The method 300 is a method of removing contaminants from a feed gas, which may be hydrocarbon-containing gas obtained from a hydrocarbon reservoir, for example at a wellhead. The method 300 can be practiced using any of the apparatus described herein.

At 302, a feed gas is provided to a vertical contactor. The feed gas may be provided to the vertical contactor at a gas feed location above a bottom of the vertical contactor. The vertical contactor is used to contact the gas with a liquid absorbent that removes the contaminants from the gas. The vertical contactor uses recycled absorbent, along with fresh absorbent, to remove the contaminants. Fresh absorbent, recycled absorbent, or a mixture thereof, may be mixed with the feed gas prior to providing to the vertical contactor. For example, an aerosol or mist of the liquid absorbent may be formed in the feed gas, and then the aerosol or mist may be flowed into the vertical contactor. The feed gas or aerosol may be heated or cooled to a target feed temperature, if desired.

At 304, the feed gas or aerosol is flowed in a gas flow direction through the vertical contactor. A contacting structure may be disposed in the vertical contactor to increase contact surface area. The gas flows through pathways formed in the contacting structure that provide high surface area for contacting a gas and a liquid at surfaces of the contacting structure.

At 306, a recycled absorbent is mixed with fresh absorbent for use in the vertical contactor. The fresh absorbent is obtained from a fresh absorbent source and mixed with the recycle absorbent in a pipe or vessel to form an absorbent mixture. As noted above, in the case of sulfur removal using a triazine, the absorbent mixture so constituted has a lower pH than the pure fresh absorbent, and therefore supports an increased effectiveness of removing contaminants compounds from the gas.

At 308, the absorbent mixture is flowed through the vertical contactor. If a contacting structure is used, the absorbent mixture is distributed onto the contacting structure. The liquid absorbent mixture can be sprayed, drizzled, misted, or otherwise distributed into the vertical contactor and/or onto the contacting structure. The liquid absorbent is distributed onto the contacting structure in a way that maximizes coating all the surfaces of the contacting structure with a film of liquid absorbent. In this way, a transport interface between the liquid absorbent and the gas is maximized so that removal of contaminants from the gas is effectively not limited by diffusion of the contaminants from the gas into the liquid.

The absorbent mixture is flowed through the contacting structure in a liquid flow direction that is counter to the gas flow direction. As the liquid encounters gas, contaminants diffuse from the gas into the liquid and are removed. In the case of an absorbent containing reactive nitrogen, sulfur compounds in the gas react with nitrogen in the absorbent. When the absorbent is a hexahydrotriazine material, sulfur compounds react with nitrogen atoms in the triazine ring, replacing the nitrogen atoms with sulfur atoms and liberating amines. As the concentration of amines increases in the liquid absorbent, pH of the liquid absorbent declines. Viscosity of the liquid absorbent may also increase.

At 310, a clean gas stream is recovered from the vertical contactor. The clean gas stream is recovered at a location downstream, in the gas flow direction, from the gas feed location. The clean gas stream is generally recovered at a location above the location where liquid absorbent is provided to the vertical contactor. In most cases, this will be at the top of the vertical contactor, but in some cases, the clean gas stream may be recovered at a location other than the top of the vertical contactor. The recycled absorbent is recovered at or near the bottom of the vertical contactor.

In some cases, multiple contacting structures can be used, each with its own liquid distributor. In such cases, at least a portion of the clean gas can be recovered at a location of the vertical contactor that is between a liquid distributor and a contacting structure above the liquid distributor. Such options can be used to manage pressure drop in one or more contacting structures when multiple such structures are used.

In some cases, pressure drop can be measured in the vertical contactor. Where contacting structures are used, the pressure drop can be measured across one or more of the contacting structures to determine whether a contacting structure has reduced flow capacity due, for example, to fouling of the contacting structure with insolubles from the liquid. Flow rate of the recycled absorbent can be adjusted based on the detected pressure drop. For example, where elevated pressure drop is detected, flow rate of recycled absorbent can be decreased to avoid liquid building in the vertical contactor. If the pressure drop is due to solids fouling from the absorbent, flow rate of fresh absorbent makeup can be increased to dilute the recycled absorbent.

Where elevated pressure drop is detected across a contacting structure, flow of liquid absorbent to the liquid distributor immediately above that contacting structure may be reduced. Alternately, flow of liquid absorbent to all liquid distributors above the affected contacting structure may be reduced. Likewise, flow of clean gas through the affected contacting structure can be reduced, if desired, by recovering clean gas from a location below the affected contacting structure.

In general, clean gas recovered from the vertical contactor is routed to a clean gas separator for removal of any residual liquid absorbent, typically by settling. The resulting clean dry gas can then be used for its intended purpose. The recovered residual liquid can be disposed of or recycled. In some cases not specifically shown in an apparatus herein, but contemplated nonetheless, clean gas recovered below a compromised contacting structure can be reinserted into the vertical contactor at a location above the compromised contacting structure, effectively bypassing the compromised contacting structure.

The chemical condition of the absorbent may be monitored as described above. One or more chemical condition detectors, which can include a pH detector, viscosity detector, density detector, an electrical conductivity or resistivity detector, a turbidity detector, and/or a molecular detector such as a gas chromatograph can be used to determine the chemical condition of the absorbent. Chemical condition of the absorbent is detected at the bottom of the vertical contactor or in the recycle absorbent line, after the absorbent has passed through the vertical contactor. The chemical condition of the absorbent is used to determine whether the absorbent should be, in part, remediated, or whether some absorbent should be removed as spent and sent to a disposal. If the chemical condition reading from the one or more chemical condition detectors indicates the chemical condition of the absorbent is out of tolerance, for example if the viscosity, density, molecular weight, or turbidity is too high, or if the pH is too low, removal of spent absorbent can be increased, makeup of fresh absorbent can be increased, or the absorbent can be filtered to remove species contributing to the out-of-tolerance readings. A controller can be used to adjust process conditions in this way. Conversely, if the chemical condition reading indicates the chemical condition of the absorbent is within tolerance, the controller can reduce fresh absorbent makeup and/or spent absorbent removal to increase absorbent utilization and reduce cost until a limit of chemical condition is approached.

In some cases, a liquid level of recycled absorbent may be maintained in the bottom of the vertical contactor. The liquid level can be monitored using a level detector to provide an additional control. For example, a flow rate of fresh absorbent can be determined based on chemical condition readings while a flow rate of spent absorbent removal is determined based on the liquid level in the vertical contactor. The converse can also be done. If feed gas rate is monitored, total absorbent flow rate to the vertical contactor, through all liquid distributors, can be adjusted based on the feed gas flow rate. Additionally, as noted above, spent absorbent flow rate can be determined and set by the controller 238 based on material balance of absorbent around the vertical contactor 201.

Relative flow rate of absorbent through the liquid distributors can also be adjusted, in cases where more than one liquid distributor is used, based on the chemical condition readings. If chemical condition is within tolerance, flow rate of absorbent to liquid distributors higher in the vertical contactor can be increased, while flow rate to liquid distributors lower in the vertical contactor can be decreased. In this way, longer contacting time between gas and liquid can be used to increase sulfur removal. The converse can also be done.

Finally, fresh absorbent can be provided in the method 300 according to two control objectives. An amount of contaminants in the feed gas can be detected using a first gas sensor, and a theoretical minimum amount of absorbent needed to absorb the contaminants can be determined from stoichiometry of the absorption reaction, if the contaminants and the absorbent are known. A controller can be used to determine the theoretical minimum amount in real time based on the signals from the various sensors and based on the flow rate of the feed gas. An amount of contaminants in the clean gas can also be detected using a second gas sensor. Fresh absorbent can be provided to the contacting structure of the vertical contactor as makeup fresh absorbent according to the determined minimum theoretical amount of absorbent, and additional fresh absorbent can be added to the feed gas for feeding to the vertical contactor if the contaminants detected in the clean gas or the chemical condition of the absorbent or the contaminants detected in the clean gas is out of tolerance. The additional fresh absorbent added to the feed gas can also be reduced if the chemical condition of the absorbent and the contaminants detected in the clean gas are within tolerance. The additional fresh absorbent added to the feed gas flows along a short pathway to the recycle absorbent system, thus providing a way to control the chemical condition of the recycle absorbent.

In an alternate method, the fresh absorbent added based on the determined minimum theoretical amount of absorbent needed can be divided between the feed and recycle locations according to any desired ratio. The additional fresh absorbent added to improve chemical condition can also be divided between the feed and recycle locations according to any desired ratio. These ratios can be set based on the chemical condition, liquid level in the vertical contactor, or other process conditions. For example, as chemical condition improves, the amount of additional fresh absorbent added can be reduced, and the ratio of fresh absorbent added at the feed location to total fresh absorbent can be reduced. As chemical condition deteriorates, the amount of additional fresh absorbent added can be increased, and the ratio of fresh absorbent added at the feed location to total fresh absorbent can be increased. By moving fresh absorbent increasingly to the feed location, the rate at which additional fresh absorbent is added to improve chemical condition can be minimized, thus minimizing overall absorbent usage.

The various control objectives and methods described above can be implemented in any convenient combination using an appropriately configured controller or collection of controllers.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

What is claimed is:

1. A method of removing contaminants from a gas, comprising:
providing a feed gas to a vertical contactor;
flowing the feed gas in a gas flow direction through the vertical contactor;
mixing a fresh absorbent makeup with a recycled absorbent to form an absorbent mixture;
providing a fresh absorbent feed to the feed gas;
flowing the absorbent mixture through the vertical contactor in a liquid flow direction counter to the gas flow direction;
recovering a clean gas stream from the vertical contactor; and
recovering the recycled absorbent from the vertical contactor.

2. The method of claim 1, further comprising detecting a chemical condition of the recycled absorbent and removing a portion of the recycled absorbent as spent absorbent at a flow rate determined based on the detected chemical condition.

3. The method of claim 2, further comprising detecting a liquid level in the vertical contactor and adjusting a flow rate of the spent absorbent based on the liquid level.

4. The method of claim 3, further comprising filtering the recycled absorbent.

5. The method of claim 4, further comprising adjusting a rate of filtering the recycled absorbent based on the chemical condition.

6. The method of claim 1, further comprising detecting an amount of contaminants in the gas feed, determining a theoretical minimum amount of absorbent needed to absorb the contaminants based on the detected amount of contaminants in the feed gas, and setting a flow rate of the fresh absorbent makeup based on the theoretical minimum.

7. The method of claim 6, further comprising detecting an amount of contaminants in the clean gas stream and adjusting a flow rate of the fresh absorbent feed to the feed gas based on the chemical condition and the contaminants detected in the clean gas stream.

8. The method of claim 1, further comprising detecting a pressure drop in the vertical contactor and adjusting a flow rate of the recycled absorbent according to the pressure drop.

9. A method of removing contaminants from a gas, comprising:
providing a feed gas to a vertical contactor;
flowing the feed gas in a gas flow direction through the vertical contactor;
mixing a fresh absorbent makeup with a recycled absorbent to form an absorbent mixture;
flowing the absorbent mixture through the vertical contactor in a liquid flow direction counter to the gas flow direction;
providing a fresh absorbent feed to the feed gas;
recovering a clean gas stream from the vertical contactor;
recovering the recycled absorbent from the vertical contactor;
detecting an amount of contaminants in the feed gas;
determining a theoretical minimum amount of absorbent needed to absorb the contaminants;
detecting a chemical condition of the recycled absorbent;
setting a flow rate of the fresh absorbent makeup to the recycled absorbent according to the theoretical minimum or the detected chemical condition; and
setting a flow rate of the fresh absorbent to the feed gas according to the theoretical minimum or the detected chemical condition.

10. The method of claim 9, further comprising detecting a liquid level in the vertical contactor and removing a portion of the recycled absorbent as spent absorbent at a flow rate based on the liquid level.

11. The method of claim 10, further comprising filtering the recycled absorbent.

12. The method of claim 11, further comprising adjusting a rate of filtering the recycled absorbent based on the chemical condition.

13. The method of claim 12, further comprising detecting a pressure drop in the vertical contactor.

14. The method of claim 13, further comprising adjusting a flow rate of the absorbent mixture based on the pressure drop.

15. A method of removing sulfur compounds from a gas, comprising:
providing a feed gas at a feed gas flow rate to a vertical contactor;
detecting an amount of sulfur compounds in the feed gas;
flowing the feed gas in a gas flow direction through the vertical contactor;
determining a theoretical minimum amount of absorbent needed to absorb the sulfur from the sulfur compounds based on the detected amount of sulfur compounds and the feed gas flow rate;
mixing a fresh absorbent makeup with a recycled absorbent at a fresh absorbent makeup flow rate at or below the theoretical minimum amount to form an absorbent mixture;
flowing the absorbent mixture through the vertical contactor in a liquid flow direction counter to the gas flow direction;
recovering a clean gas stream from the vertical contactor;
detecting a chemical condition of the recycled absorbent;
detecting an amount of sulfur compounds in the clean gas;
providing a fresh absorbent feed to the vertical contactor along with the feed gas at a fresh absorbent feed flow rate based on the detected chemical condition and the detected amount of sulfur compounds in the clean gas; and
recovering the recycled absorbent from the vertical contactor.

16. The method of claim 15, further comprising filtering the recycled absorbent.

17. The method of claim 18, further comprising adjusting a rate of filtering the recycled absorbent based on the detected chemical condition.

18. The method of claim 17, further comprising detecting a liquid level in the vertical contactor and removing a portion of the recycled absorbent as spent absorbent at a flow rate based on the liquid level.

19. The method of claim 18, further comprising detecting a pressure drop in the vertical contactor and adjusting a flow rate of the recycled absorbent according to the pressure drop.

20. A method, comprising:
removing contaminants from a gas in a vertical contactor by counter-flow contact between the gas and an absorbent;
recycling a portion of the absorbent to the vertical contactor;
adding fresh absorbent to the recycled absorbent at a rate equal to the stoichiometric amount of absorbent needed to remove the contaminants; and
adding fresh absorbent to the gas prior to entry into the vertical contactor at a rate determined by sensing the chemical condition of the recycled absorbent.
